(19) United States
(12) Patent Application Publication
(10) Pub. No.: US 2009/0000336 A1
(43) Pub. Date: Jan. 1, 2009

(54) Inner Treatment Method and Device for the Inner Treatment of Glass Containers

(75) Inventor: Siegfried Rosler, Essen (DE)

Correspondence Address: SUGHRUE MION, PLLC, 2100 PENNSYLVANIA AVENUE, N.W., SUITE 800, WASHINGTON, DC, 20037, US

(73) Assignee: GERRESHEIMER ESSEN GMBH, Essen (DE)

(21) Appl. No.: 12/095,280

(22) PCT Filed: Mar. 16, 2006
(86) PCT No.: PCT/EP2006/002427

§ 371 Date: Sep. 16, 2008

(30) Foreign Application Priority Data
Nov. 30, 2005 (DE) 10 2005 057 423.8

(51) Int. Cl. C03B 9/00

(52) U.S. Cl. 65/158

(57) ABSTRACT

The present invention relates to a method for the inner treatment of a glass container (4) in which
a free-flowing treatment agent (6) is apportioned so as to correspond to the size of the glass container (4) to be treated and
a portion formed in this way is transported by means of a portion feeder (1) through the mouth of the glass container into the, preferably still hot, interior of the glass container
   and to an inner treatment device and systems comprising such inner treatment devices for carrying out the method according to the invention.

The present invention relates to an inner treatment method and device for the inner treatment of glass containers.

To allow medicaments or distilled water, for example, to be stored for years in glass containers, preferably bottles made of blow-molded glass, these glass containers must be made of glass of hydrolytic Class 1 (Class HC 1 of the standard ISO 4802 or type I of Ph. Eur. 5.0 [Pharmacopoeia Europaea Version 5.0]), under item 3.2.1 there, or made as treated glass containers of so-called Class 2 (Class HC 2 of the standard ISO 4802 or type II of Ph. Eur. 5.0).

Since glass of Class 1 (HC 1 in accordance with ISO 4802, type I in accordance with Ph. Eur. 5.0/3.02.01.00) is very cost-intensive in the production process, the glass containers are made of glass of Class 3 (HC 3 in accordance with ISO 4802, type III in accordance with Ph. Eur. 5.0/3.02.01.00) and the inner surface of these containers is treated to achieve the values of Class 2 (HC 2 in accordance with ISO 4802, type II in accordance with Ph. Eur. 5.0/3.0 2.01.00).

The aim of the treatment of the inner surface is to extract the sodium from the surface of the glass, preferably the inner surface of a glass container, and in this way lower the content of cations in order to make it hydrolytically more resistant. There are various methods for carrying out this so-called inner treatment.

In glassworks, for instance, ammonium chloride tablets have been used since the 1960s for this method of inner treatment. The tablets with a diameter of preferably about 7 mm and preferably a thickness of about 2.5 mm and weighing 0.15 g were formerly thrown by hand into the individual glass containers at a temperature of about 600° C., after which the treatment agent (here the ammonium chloride) evaporates as a result of the heat effect and is deposited as a coating on the surfaces of the interior of the glass container.

For some considerable time, machines, known as tablet throwers, have also been used for this. With a rising increase in the output of the bottle production machines, however, even if two tablets are thrown into each bottle it is still not always possible to ensure flawless inner treatment.

The price of these ammonium chloride tablets was and is very high; for instance, in 1985 it was about DM 40 per kg, which still more or less holds true today. With an average number of 150 bottles/minute, the approximate consumption for 50 ml infusion bottles=300 tablets/minute, each weighing 0.15 g (with 2 tablets for each bottle to increase the reliability of the treatment). This corresponds to about 64.8 kg/24 hours. This tablet treatment is consequently very expensive, but nevertheless regrettably not reliable enough, since, even with double the tablets thrown, it cannot always be ensured that they also actually end up in the interior of each glass container through the mouth of the container. This results in complaints, and consequently additional costs, for the glass producer.

This treatment method consequently has the disadvantage of very high costs, with at the same time not always adequately ensured quality.

To be able even to treat the inside of small glass containers with a small inner diameter of the mouth (that is to say those with a small bottle opening), ammonium chloride may also be used in the form of a “powder”. The hot glass containers on the production machine belt are in this case diverted onto a small flange-mounted co-running belt, over which a constant stream of ammonium chloride powder is then sprinkled by means of, for instance, a worm conveyor.

Although the quality of the inner treatment of such glass containers is adequate, it is at the lower limit. Moreover, the production sequence involves considerable dust and dirt and therefore can only be carried out very poorly in practice.

For the aforementioned reasons, a further inner treatment method is therefore used: the glass containers are brought into a so-called annealing oven, the internal atmosphere of which is sealed from the surroundings and is mixed with a gas of a treatment agent that does not have to be the expensive ammonium chloride that is used for the tablet form (less expensive treatment agents, such as for instance ammonium sulfate, which is highly hygroscopic, are not suitable for the production of tablets). The treatment agent is then deposited on the surface of the glass containers inside the annealing oven and they are treated in this way with adequate quality (on the inside and outside).

Although with this method the use of expensive ammonium chloride tablets can be avoided and adequate treatment quality achieved, it has the disadvantage of being extremely inflexible with regard to suitable treatment batch sizes, since the annealing oven used for this purpose can only be used for glass containers to be treated, since the treatment agent is deposited everywhere inside the oven and it consequently can no longer be used for batches without the desired treatment. Consequently, however, from economic aspects, it is necessary for the corresponding capital-intensive oven to be used to full capacity just for batches of glass containers to be treated. Consequently, use of this treatment method is ruled out for relatively small batches. Moreover, the method also has the disadvantage of always treating the entire glass container and not just its interior.

In spite of the notorious economic and/or technical disadvantages of all the known treatment methods, for decades there has been no known method that avoids all of the aforementioned disadvantages. Rather, the known methods are either expensive, unreliable or inflexible with regard to relatively small batches.

Against this background of the prior art, it is the object of the present invention to provide an inner treatment method for glass containers and an inner treatment device that avoid the aforementioned disadvantages, at the same time ensure reliable inner treatment, allow the targeted use of a low-cost treatment agent and can also be economically used for relatively small batches.

This object is achieved by a method for the inner treatment of a glass container in which
a free-flowing, for instance grainy, treatment agent, preferably in the form of granules or powder, with particular preference ammonium sulfate, is apportioned so as to correspond to the size of the glass container to be treated and
a portion formed in this way is transported by means of a portion feeder into the, preferably still hot, interior of the glass container through the mouth of the glass container.

The still hot interior of a glass container is to be understood here as meaning one in which the temperature is still so high that the introduction of the treatment agent still leads to treatment of the glass surface in the interior of the glass container. In the case of using ammonium sulfate as the treatment agent, the temperature must be set so as to cause a reaction in which the ammonium sulfate reduces the sodium in the surface of the glass of the interior of the container, which leads to fewer cations there, and in this way treats the glass, producing ammonium bisulfate and ammonia. Whether such a reaction can take place to an extent sufficient for the treatment is dependent here in particular on the temperature of the glass container at the time that the treatment agent is introduced into the glass container and the time that is subsequently still available for cooling down. In the case of introduction at a lower temperature, a longer subsequent cooling period is needed, in the case of higher temperature a shorter time period. The same applies to the possible use of treatment agents other than ammonium sulfate.

Particularly good treatment results have been obtained with ammonium sulfate in a range from about 350° C. to about 500° C., preferably 350° C. to 500° C., for the temperature of the glass container. Even at higher temperatures around about 600° C., preferably at 600° C., satisfactory results can be obtained with the method according to the invention. As the cooling time to a temperature of about 80° C., preferably of 80° C., a time period of approximately one hour (1 h), preferably one hour, was in each case available.

However, it is also possible to introduce the treatment agent, preferably the ammonium sulfate, also into the already cooled interior of the glass container and then treat it by reheating, for instance in a so-called burning-in oven, as is used for instance for fixing bottle imprints. This procedure is also known as ‘aftertreatment’. The statements made above concerning the temperature for treatment apply here correspondingly.

The solution also serves for achieving the object of an inner treatment device for the inner treatment of glass containers comprising at least one portion feeder, which is designed for instance as a preferably circular feeder wheel with at least one portion container, which in the case of arrival of a glass container in the region of the portion feeder, preferably the feeder wheel, for instance by rotation of the same, that is established by a detection means, is emptied into the glass container.

The arrival of a glass container can be established by means of suitable detection means, such as for instance light barriers or other proximity sensors, for instance on a conveyor belt. The required synchronization between the portion feeder and the glass container, triggered in this case by the detection means, may be realized intermittently, for instance by a step control. This involves determining for example the time that elapses between detection of the glass container—for instance on a conveyor belt at a constant speed or speed to be measured (to be measured for example by means of an angle encoder on a drive spindle of the belt)—and the filling time to be observed—for instance when the glass container is as exactly as possible underneath the portion feeder—as well as the time that the portion feeder requires in each case until the next emptying, and then sets the sequential control—for instance by means of a correspondingly set delay element—in such a way that the portion feeder is only ever emptied once the glass container, after prior detection, has arrived in position such that the treatment agent can also be transported into its interior, that is to say for example can flow into it. Instead of such intermittent control, however, any other kind of open-loop or closed-loop control that suitably synchronizes the emptying time also comes into consideration, that is to say for instance electronic speed control of the portion feeder and/or conveyor belt, with for example electronic synchronization (so-called electronic shaft). Preferably, the position of the detection of the glass container will be chosen a little before the actual emptying location, in order to have sufficient time available for the synchronization described above—however it is carried out.

In a preferred embodiment of the inner treatment device according to the present invention, the portion feeder, preferably a feeder wheel acting as such, serves not only for the feeding of portions into the interior of the glass container, but even also for the apportioning, that is to say for instance the composing of a portion of a certain size, of the treatment agent. This may take place by the respective portion container to be filled being dimensioned so as to correspond to the size of the glass container to be treated and receiving the treatment agent up to its maximum filling amount at a receiving location, preferably under a filling hopper and/or a—preferably hopper-shaped—filling duct. In the case of use of a feeder wheel, reception is limited for instance by a stripper just above the upper edge (a distance preferably less than the grain size of the treatment agent) and consequently in a way corresponding to the filling capacity of the portion container, when the feeder wheel makes the ready-to-receive portion container turn past the receiving location, in that the stripper strips away any excess treatment agent as a result of the rotation of the feeder wheel, preferably at least also via a channel, for instance into a collector, preferably to a feeding device for feeding back into the circulation of material. The channel may in this case preferably also be formed by the stripper itself, in that it is for instance formed in a channel-shaped manner over the course of its length.

In a particularly preferred embodiment, the feeder wheel has portion containers arranged over its circular circumference or parallel thereto, preferably at equal arcuate intervals, so that one of the portion containers is filled at the receiving location and at the same time another is emptied into the glass container that is to be treated just then. In addition, preferably at the same time, a number of portion containers in the empty state are transported from where the treatment agent is emptied into the glass container in the direction of the receiving location and filled portion containers are transported from the receiving location in the direction of where the treatment agent is emptied into the glass container.

In a further particularly preferred embodiment according to the present invention, the feeder wheel is designed as a preferably upright dosing wheel, with portion containers let into the circumference of the wheel.

The inner treatment device according to the invention described above may be arranged individually, or to increase the reliability of treatment also in series of two or more one behind the other, on the conveyor belt in glass production and so form an inner treatment system, in the case of the use of two inner treatment devices according to the invention that are arranged one behind the other their feeder wheels preferably rotating in opposite directions, which then advantageously makes it possible to arrange strippers respectively in such a way that they strip away the excess treatment agent into a common collector arranged between the two devices, preferably in the middle, preferably for feeding back into the circulation of material.

The inner treatment device according to the invention is preferably intended for glass containers that are still hot (about 350° C.-about 500° C., but also up to about 600° C.).

With the present invention, good inner treatment is ensured, treatment in which, after the production of the glass containers, an exactly dosed agent can be introduced into the containers in a continuous process on the machine belt. The correct and constant feeding of treatment agent can be ensured here for the success of the inner treatment method.

The device and method according to the present invention represent an invention that can be used in the harsh conditions of operation in a glassworks, with which it is possible, inter alia, to carry out highly successful inner treatment of glass containers that is inexpensive and at the same time also economic for small production batches. The treatment agent that is used with preference is ammonium sulfate, technically in the form of crystals. Ammonium sulfate is not a hazardous substance under German chemical law. The price for this material is currently around ε0.30/kg.

With the present invention, a dosed amount of treatment agent (including small and extremely small amounts) can be fed in a free-flowing, for instance grainy, state to each individual glass container with unhindered passage (without contact).

If it is embodied as a closed, mobile unit, the apparatus according to the invention can be placed in any prepared production line. The capacity of the apparatus (of the device) is preferably about 600 bottles per minute. Easy adjustment is also possible if the article is changed. The dosed amount can be easily changed, preferably by simply exchanging the feeder wheel, for instance the respective dosing wheel, for one with a new portion container/new portion containers and a new size.

Exemplary embodiments are discussed below on the basis of the drawing, without intending to be restrictive. In the drawing:

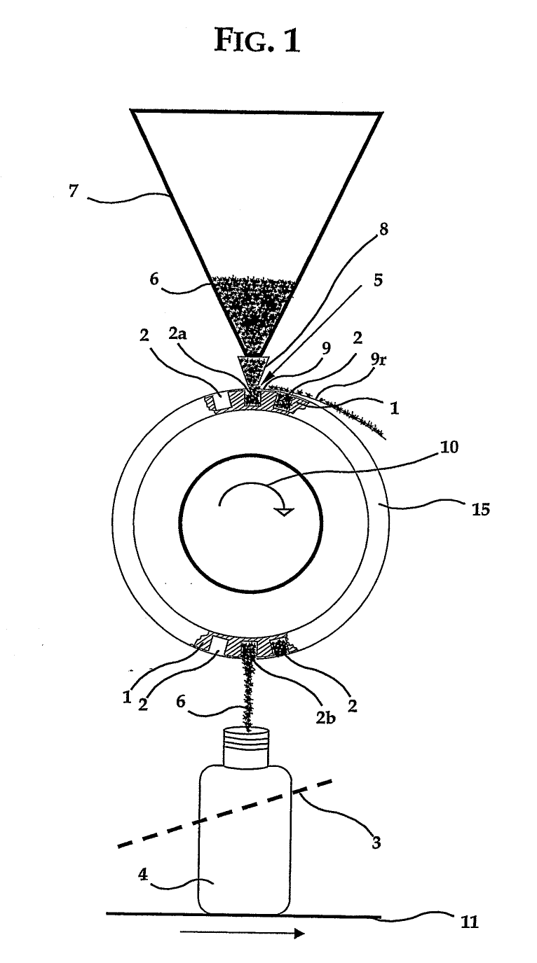

FIG. 1 shows an embodiment of an inner treatment device according to the invention in a basic representation from the front side,

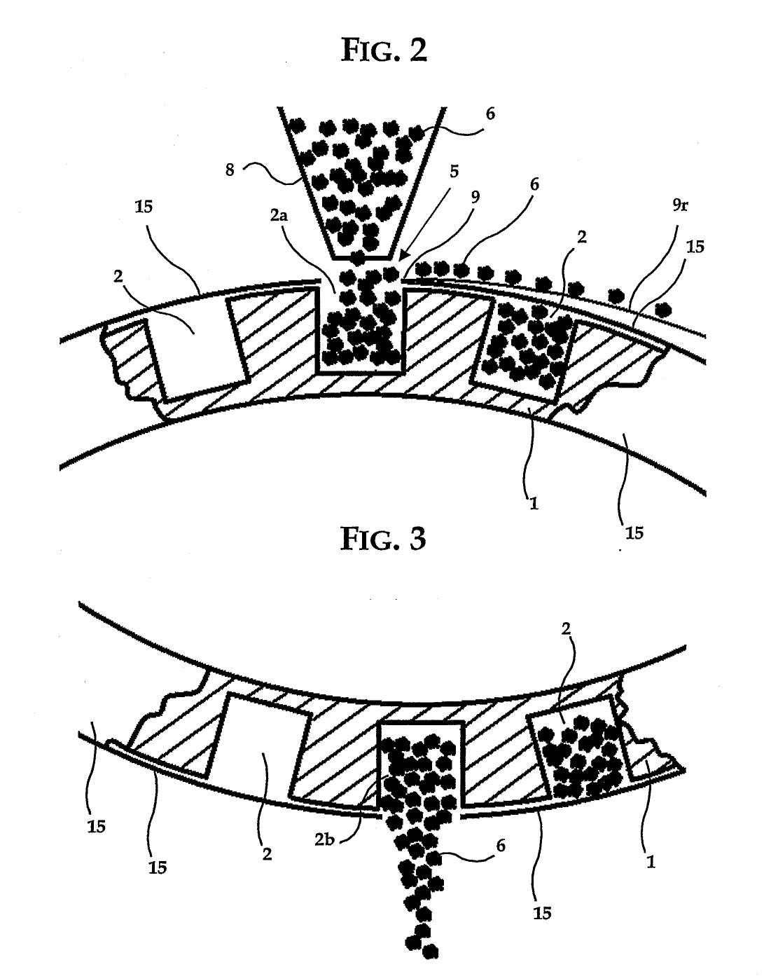

FIG. 2 shows an enlarged detail from the representation that is shown in FIG. 1 in the region of the receiving location at the upper edge of the feeder wheel,

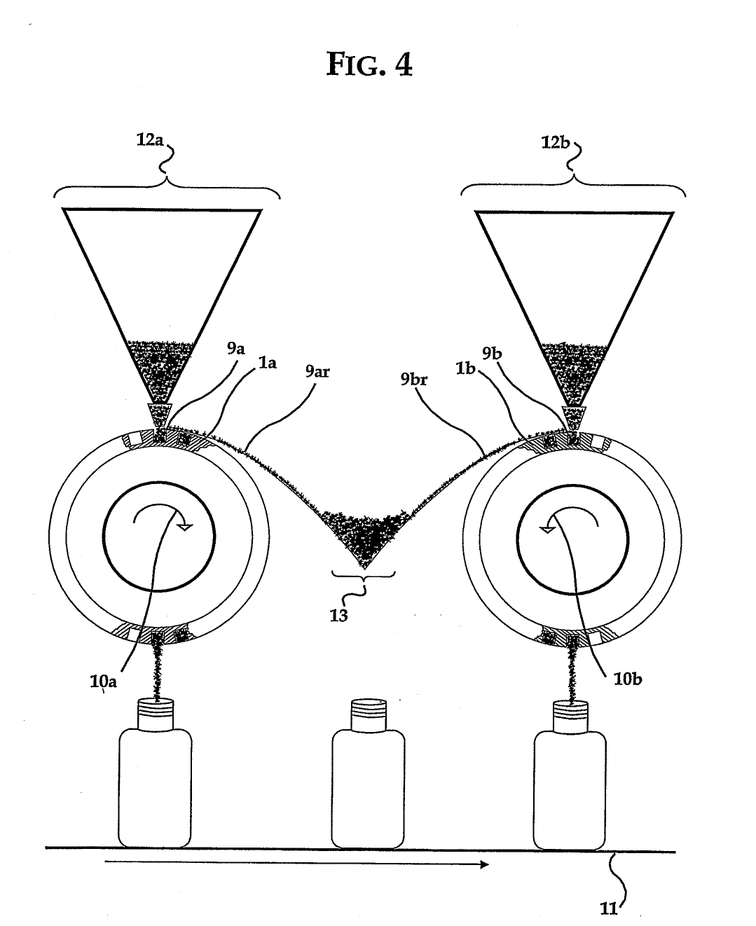

FIG. 3 likewise shows an enlarged detail from the representation that is shown in FIG. 1, here in the region of the emptying location at the lower edge of the feeder wheel,

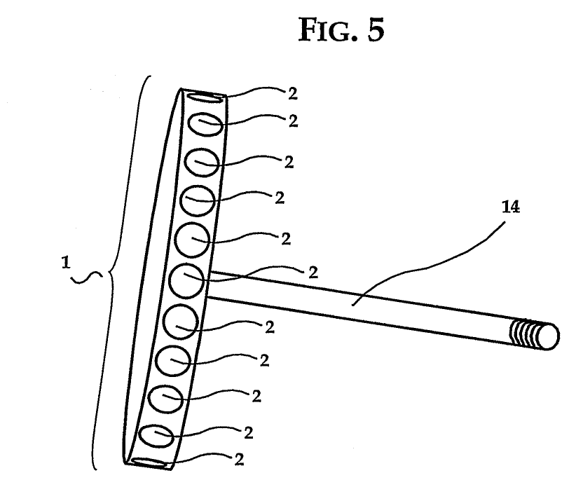

FIG. 4 shows a basic representation in front view of an inner treatment system according to the invention, with two inner treatment devices which are arranged in series one behind the other on the conveyor belt in glass production, respectively having strippers which strip away the excess treatment agent into a common collector, preferably for feeding back into the circulation of material, and the feeder wheels of which rotate in opposite directions, and

FIG. 5 shows an embodiment of a circular feeder wheel according to the present invention as an upright dosing wheel, with portion containers that are let into the circumference of the wheel, in a perspective side view.

FIG. 1 shows an embodiment of an inner treatment device according to the invention in a basic representation from the front side. By its nature of being a basic representation, the relative sizes of the components that can be seen here do not necessarily coincide with the actual relative sizes, which also applies to the other figures represented here. The inner treatment device that can be seen here has a portion feeder 1, which is designed as a feeder wheel with portion containers 2, 2a, 2b, in the case of which, whenever arrival of a glass container 4 on a conveyor belt 11 in the region underneath the feeder wheel 1 by rotation of the same is established by a detection means 3, here a light barrier, a portion container 2, 2a, 2b is emptied into the glass container 4. For this purpose, the portion containers 2, 2a, 2b are arranged on the circular circumference of the feeder wheel 1—preferably at equal arcuate intervals—whereby one of the portion containers 2a is filled at the receiving location 5 and at the same time another portion container 2b is emptied into the glass container 4 to be treated just then. The circular feeder wheel 1 is in this case designed as an upright dosing wheel, in the case of which the portion containers 2, 2a, 2b are let into the circumference of the wheel, for instance as blind-hole bores, and which rotates in a surround 15, for instance a housing as here. The surround 15 has at the receiving location 5 and at the bottom, where the portion containers 2b are respectively emptied, openings toward the receiving location 5 and for emptying, preferably upward or downward, as here, in order that here the treatment agent 6 can pass through. In the representation, therefore, it is also the case that not all parts of the dosing wheel 1 can be seen. Only the shaded parts of the surround 15, i.e. those parts shown ‘broken open’ in graphic terms in the representation to allow the function to be seen, reveal the wheel 1 lying behind and its portion containers 2, 2a, 2b, some in their state of being filled with treatment agent 6, some in an unfilled state.

The round feeder wheel 1, formed here as a dosing wheel, serves in the present case not only for the feeding of portions into the interior of the glass container 4, but also for the apportioning itself of the treatment agent 6.

This is achieved by the respective portion container 2a to be filled being dimensioned so as to correspond to the size of the glass container 4 to be treated and receiving the treatment agent 6 up to its maximum filling amount at a receiving location 5, preferably under a filling hopper 7 and a—here preferably likewise hopper-shaped—filling duct 8.

The reception of the treatment agent 6 in the respective portion container 2a at the receiving location 5 is limited here moreover by a stripper 9 just above the height of the upper edge of the feeder wheel 1, and consequently in a way corresponding to the filling capacity of the portion container 2a, when the feeder wheel 1 makes the ready-to-receive portion container 2a turn past the receiving location 5, in that the stripper 9 strips away any excess treatment agent 6 as a result of the rotation 10 of the feeder wheel 1, via a channel 9r formed here by the stripper itself over the course of its length, preferably in the direction of a collector, for instance for reuse. The distance between the height of the upper edge of the dosing wheel 1 forming the feeder wheel and the stripper 9 is in this case chosen such that it is less than the grain size—for instance the average grain size, preferably the smallest occurring grain size—of the treatment agent 6 that is used. In the present case, the stripper 9 coincides with its end with the edge of the upper opening of the surround 15 at an acute angle, thereby forming a wedge which strips away the excess particles of the treatment agent 6 particularly well; for details, reference is also additionally made in particular to the following FIG. 2, which allows a representation of the details on a larger scale. Preferably, here the stripper 9 and the surround 15 are firmly connected to each other in their coinciding line, for instance by being welded or adhesively bonded, or else produced in one piece.

The stripper 9 strips away the excess treatment agent 6, here via a channel 9r, which here it forms itself over the further course of its length, into a collector—which cannot be seen here—which preferably serves for feeding it back into the circulation of material, it having to be noted that—for this purpose in particular—the inner treatment device according to the invention may have not only the filling hopper 7 but also further storage containers, such as for instance a larger storage hopper (which cannot be seen here).

FIG. 2 shows an enlarged detail from the representation that is shown in FIG. 1 in the region of the receiving location 5 at the upper edge of the feeder wheel 1. The reference numerals that are used correspond here to the description from FIG. 1, to which reference should also be made with respect to the further description.

FIG. 3 shows an enlarged detail from the representation that is shown in FIG. 1, here in the region of the emptying location at the lower edge of the feeder wheel 1. The reference numerals that are used correspond here to the description from FIG. 1. Here, too, reference should be made to FIG. 1 for the further description.

FIG. 4 shows an inner treatment system according to the invention in a basic representation in front view, with two inner treatment devices 12a, 12b, which are arranged in series one behind the other on the conveyor belt 11 in glass production and which respectively have strippers 9a, 9b which strip away the excess treatment agent via a channel 9ar, 9br into a common collector 13, preferably for feeding back into the circulation of material, and the feeder wheels 1a, 1b of which rotate in opposite directions 10a, 10b.

FIG. 5 shows an embodiment of the portion feeder in the form of a circular feeder wheel 1 according to the present invention as an upright dosing wheel with portion containers 2 let into the circumference of the wheel, in a perspective side view, the dosing wheel 1 here having a spindle 14 with a thread at the end. The thread serves in this case for fastening the spindle on a drive by screwing it in. The spindle may, however, also be formed as an insert spindle, preferably with a bayonet fastener, it being possible for it to be exchanged even more easily by means of an insert profile located at the end of the spindle 14. In any event, inner treatment devices or systems according to the invention can be easily adapted so as to correspond to the requirements for the production of glass containers of different sizes by means of such exchangeable, different dosing wheels 1, serving as a feeder wheel, the portion containers 2 of which are designed for different glass container sizes.

1-23. (canceled)

24. An inner treatment device for the inner treatment of hot glass containers (4) at 350° C. to 600° C. comprising at least one portion feeder (1), which has at least one portion container (2, 2a, 2b), in which case, whenever arrival of a glass container (4) in the region underneath the portion feeder (1) is established by a detection means (3), a free-flowing treatment agent is emptied into the glass container (4), and in which case the portion feeder (1) serves not only for the feeding of portions into the interior of the glass container (4), but also for the apportioning of the treatment agent (6) itself.

25. The inner treatment device for the inner treatment of hot glass containers (4) as claimed in claim 24, characterized in that a light barrier which establishes the arrival of the glass container (4) on a conveyor belt (11) in the region of the portion feeder (1) is used as the detection means (3).

26. The inner treatment device for the inner treatment of hot glass containers (4) as claimed in claim 24, characterized in that the respective portion container (2a) to be filled is dimensioned so as to correspond to the size of the glass container (4) to be treated and receives the treatment agent (6) up to its maximum filling amount at a receiving location (5), preferably under a filling hopper (7) and/or a filling duct (8).

27. The inner treatment device for the inner treatment of hot glass containers (4) as claimed in claim 24, characterized in that the portion feeder (1) is designed as a feeder wheel with at least one portion container (2, 2a, 2b), which, whenever arrival of a glass container (4) in the region of, preferably underneath, the feeder wheel (1) by rotation (10) of the same is established by a detection means (3), is emptied into the glass container (4).

28. The inner treatment device for the inner treatment of hot glass containers (4) as claimed in claim 27, characterized in that the feeder wheel (1) is designed in a circular manner.

29. The inner treatment device for the inner treatment of hot glass containers (4) as claimed in claim 27, characterized in that the respective portion container (2a) to be filled receives the treatment agent (6) at a receiving location (5), preferably under a filling hopper (7) and/or a filling duct (8), and the reception is limited by a stripper (9) over the upper edge of the feeder wheel (1), and consequently in a way corresponding to the filling capacity of the portion container (2a), when the feeder wheel (1) makes the ready-to-receive portion container (2a) turn past (10) the receiving location (5), in that the stripper (9) strips away any excess treatment agent (6) as a result of the rotation (10) of the feeder wheel (1).

30. The inner treatment device for the inner treatment of hot glass containers (4) as claimed in claim 29, characterized in that a distance made less than the grain size of the treatment agent (6) that is used is chosen as the distance between the upper edge of the feeder wheel (1) and the stripper (9).

31. The inner treatment device for the inner treatment of hot glass containers (4) as claimed in claim 29, characterized in that the stripper (9) strips away the excess treatment agent (6), preferably via a channel (9r), into a collector (13).

32. The inner treatment device for the inner treatment of hot glass containers (4) as claimed in claim 27, characterized in that the feeder wheel (1) has a number of portion containers (2, 2a, 2b) arranged over its circular circumference or parallel thereto, preferably at equal arcuate intervals, in such a way that one of the portion containers (2a) is filled at the receiving location (5) and at the same time another portion container (2b) is emptied into the glass container (4) that is to be treated just then.

33. The inner treatment device for the inner treatment of hot glass containers (4) as claimed in claim 27, characterized in that the feeder wheel (1) is designed as an upright dosing wheel with portion containers (2, 2a, 2b) let into the circumference of the wheel.

34. An inner treatment system comprising at least two inner treatment devices (12a, 12b) respectively as claimed in claim 24, characterized in that the inner treatment devices (12a, 12b) are arranged in series one behind the other on the conveyor belt (11) in glass production.

35. The inner treatment system as claimed in claim 34, characterized in that two inner treatment devices (12a, 12b) are arranged in series one behind the other on the conveyor belt (11) in glass production and their feeder wheels (1a, 1b) rotate in opposite directions (10a, 10b).

36. The inner treatment system as claimed in claim 35, characterized in that both inner treatment devices (12a, 12b) that are arranged in series one behind the other on the conveyor belt (11) in glass production respectively have strippers (9a, 9b) which strip away the excess treatment agent (6) into a common collector (13), preferably for feeding back into the circulation of material.
